(19) United States
(12) Patent Application Publication
(10) Pub. No.: US 2013/0044799 A1
(43) Pub. Date: Feb. 21, 2013

(54) Method of Handling Geodesic Interpolation for MIMO Precoding and Related Communication Device

(71) Applicants: Pang-Chang Lan, Taipei City (TW); Chih-Yao Wu, Taoyuan County (TW); Ling-San Meng, Taipei City (TW); Ping-Cheng Yeh, Taipei City (TW); Yu-Chih Jen, Taoyuan County (TW)

(72) Inventors: Pang-Chang Lan, Taipei City (TW); Chih-Yao Wu, Taoyuan County (TW); Ling-San Meng, Taipei City (TW); Ping-Cheng Yeh, Taipei City (TW); Yu-Chih Jen, Taoyuan County (TW)

(21) Appl. No.: 13/396,615

(22) Filed: Feb. 15, 2012

Related U.S. Application Data
(60) Provisional application No. 61/442,820, filed on Feb. 15, 2011.

(51) Int. Cl. H04B 7/06

(52) U.S. Cl. 375/224

(57) ABSTRACT

A method of reducing quantization error caused by precoding for a receiver in a wireless communication system is disclosed. The method comprising measuring channel information of a channel between the receiver and a transmitter in the wireless communication system; determining at least one precoding matrix from at least one codebook according to the channel information of the channel; determining at least one geometric coefficient according to a Geodesic interpolation algorithm and the at least one precoding matrix, for the at least one precoding matrix, respectively; and feeding back the at least one precoding matrix and the at least one geometric coefficient to the transmitter.

### CROSS REFERENCE TO RELATED APPLICATIONS

This application claims the benefit of U.S. Provisional Application No. 61/442,820, filed on Feb. 15, 2011 and entitled “Methods and Apparatus of Geodesic Interpolation for Refining MIMO Precoder Codebook”, the contents of which are incorporated herein in their entirety.

### BACKGROUND OF THE INVENTION

1. Field of the Invention

The present invention relates to a method used in a wireless communication system and related communication device, and more particularly, to a method of applying Geodesic interpolation to precoding for MIMO and related communication device.

2. Description of the Prior Art

A long-term evolution (LTE) system supporting the 3GPP Rel-8 standard and/or the 3GPP Rel-9 standard are developed by the 3rd Generation Partnership Project (3GPP) as a successor of a universal mobile telecommunications system (UMTS), for further enhancing performance of the UMTS to satisfy increasing needs of users. The LTE system includes a new radio interface and a new radio network architecture that provides a high data rate, low latency, packet optimization, and improved system capacity and coverage. In the LTE system, a radio access network known as an evolved universal terrestrial radio access network (E-UTRAN) includes multiple evolved Node-Bs (eNBs) for communicating with multiple UEs, and communicates with a core network including a mobility management entity (MME), a serving gateway, etc., for Non Access Stratum (NAS) control.

A LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint transmission/reception (COMP), UL multiple-input multiple-output (MIMO), up to 8 transmission layers on DL MIMO, etc. For a UE and an eNB to communicate with each other in the LTE-A system, the UE and the eNB must support standards developed for the LTE-A system, such as the 3GPP Rel-10 standard or later versions.

In detail, multiple transmit antennas at a transmitter and possibly multiple receive antennas at a receiver are used for realizing the MIMO. For example, a UE and an eNB can be the transmitter and the receiver, respectively. Alternatively, the UE and the eNB can be the receiver and the transmitter, respectively. Then, a channel consisting of multiple sub-channels between the transmitter and the receiver are established by the MIMO. Thus, when data are transmitted to the receiver via the channel (i.e., the sub-channels), spatial diversity and spatial multiplexing are obtained and performance (e.g. data rate) of the receiver is improved. Besides, precoding can be used to further improve efficiency of the MIMO. When the precoding is applied to the MIMO, more data are allocated to sub-channels with better channel quality, and less data are allocated to sub-channels with worse channel quality. That is, when there is a channel consisting of multiple sub-channels between the transmitter and the receiver, a corresponding precoding matrix can be determined and used for the channel, to allocate data according to channel information of the channel (i.e., channel qualities of the sub-channels). Thus, the performance of the receiver is further improved. However, the channel information of the channel should be available at the transmitter when performing the precoding for the MIMO. Preferably, the channel information is measured by the receiver and is fed back to the transmitter.

However, an amount of the channel information is usually large, and large overhead is required feeding back the entire channel information. To solve this problem, a codebook can be stored in both the transmitter and the receiver for storing precoding matrices. When the receiver measures the channel information of the channel, a corresponding precoding matrix (e.g. an optimal precoding matrix perfectly matching the channel) can be determined from the codebook. And the receiver can simply feed back an index of the corresponding precoding matrix to the transmitter, and only low overhead is required for feeding back the index. A problem of using the codebook is that an amount of the precoding matrices stored in the codebook is limited, but the channel information of the channel that may exist between the transmitter and the receiver is not. Thus, the receiver can only determine a precoding matrix which is closed to the optimal precoding matrix perfectly matching the channel from the codebook, and quantization error is caused due to mismatch between the precoding matrix and the optimal precoding matrix. A possible solution is to increase the amount of the precoding matrices stored in the codebook such that the mismatch between the precoding matrix and the optimal precoding matrix is reduced. However, storage required for storing the codebook is increased, and complexity for determining (i.e., searching) the precoding matrix is also increased. Therefore, how to reduce the overhead and the quantization error caused by the precoding when applying the precoding to the MIMO is a topic to discussed and addressed.

### SUMMARY OF THE INVENTION

The present invention therefore provides a method and related communication device for applying Geodesic interpolation to precoding for MIMO to solve the abovementioned problems.

A method of reducing quantization error caused by precoding for a receiver in a wireless communication system is disclosed. The method comprising measuring channel information of a channel between the receiver and a transmitter in the wireless communication system; determining at least one precoding matrix from at least one codebook according to the channel information of the channel; determining at least one geometric coefficient according to a Geodesic interpolation algorithm and the at least one precoding matrix, for the at least one precoding matrix, respectively; and feeding back the at least one precoding matrix and the at least one geometric coefficient to the transmitter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a schematic diagram of simulation results for comparing capacities achieved by different precoding methods.

### DETAILED DESCRIPTION

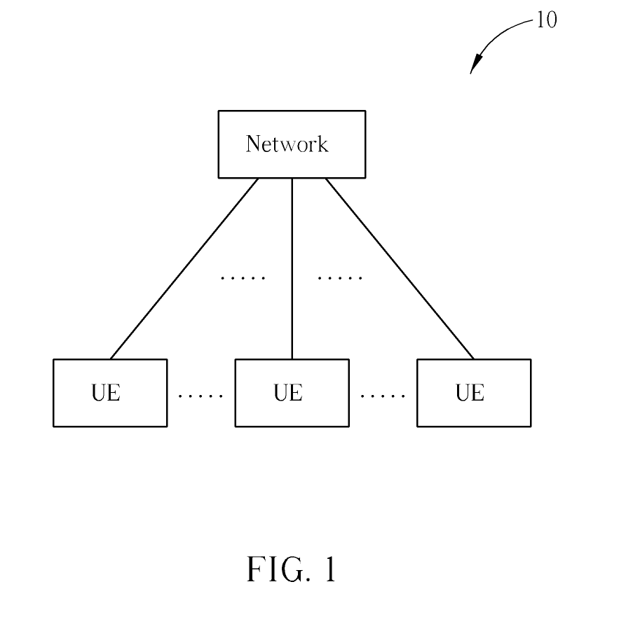

Please refer to FIG. 1, which is a schematic diagram of a wireless communication system 10 according to an example of the present invention. The wireless communication system 10 is briefly composed of a network and a plurality of user equipments (UEs), wherein the network and the UEs support multiple-input multiple-output (MIMO), multiple-input single-output (MISO) and precoding for improving efficiency of the MIMO and the MISO. In FIG. 1, the network and the UEs are simply utilized for illustrating the structure of the wireless communication system 10. Practically, the network can be a universal terrestrial radio access network (UTRAN) comprising a plurality of Node-Bs (NBs) in a universal mobile telecommunications system (UMTS). Alternatively, the network can be an evolved UTRAN (E-UTRAN) comprising a plurality of evolved NBs (eNBs) and relays in a long term evolution (LTE) system or a LTE-Advanced (LTE-A) system. Further, the network can be an access point (AP) conforming to the IEEE 802.11 standard, and is not limited herein. The UEs can be mobile devices such as mobile phones, laptops, tablet computers, electronic books, and portable computer systems. Besides, the network and a UE can be seen as a transmitter or a receiver according to transmission direction, e.g., for an uplink (UL), the UE is the transmitter and the network is the receiver, and for a downlink (DL), the network is the transmitter and the UE is the receiver.

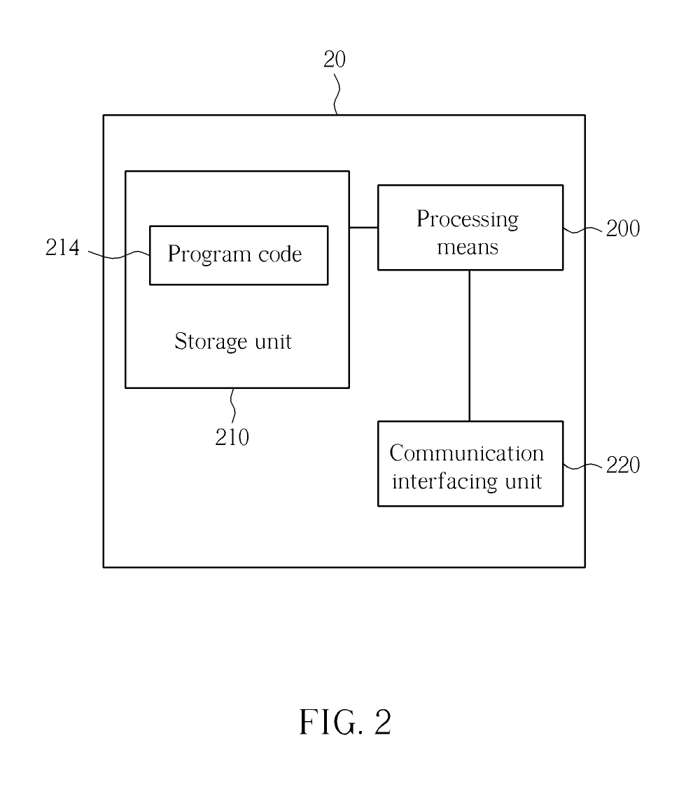

Please refer to FIG. 2, which is a schematic diagram of a communication device 20 according to an example of the present invention. The communication device 20 can be a UE or the network shown in FIG. 1, but is not limited herein. The communication device 20 may include a processing means 200 such as a microprocessor or an Application Specific Integrated Circuit (ASIC), a storage unit 210 and a communication interfacing unit 220. The storage unit 210 may be any data storage device that can store a program code 214, accessed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk, optical data storage device and solid-state drive (SSD). The communication interfacing unit 220 is preferably a radio transceiver and can transmit and receive wireless signals according to processing results of the processing means 200.

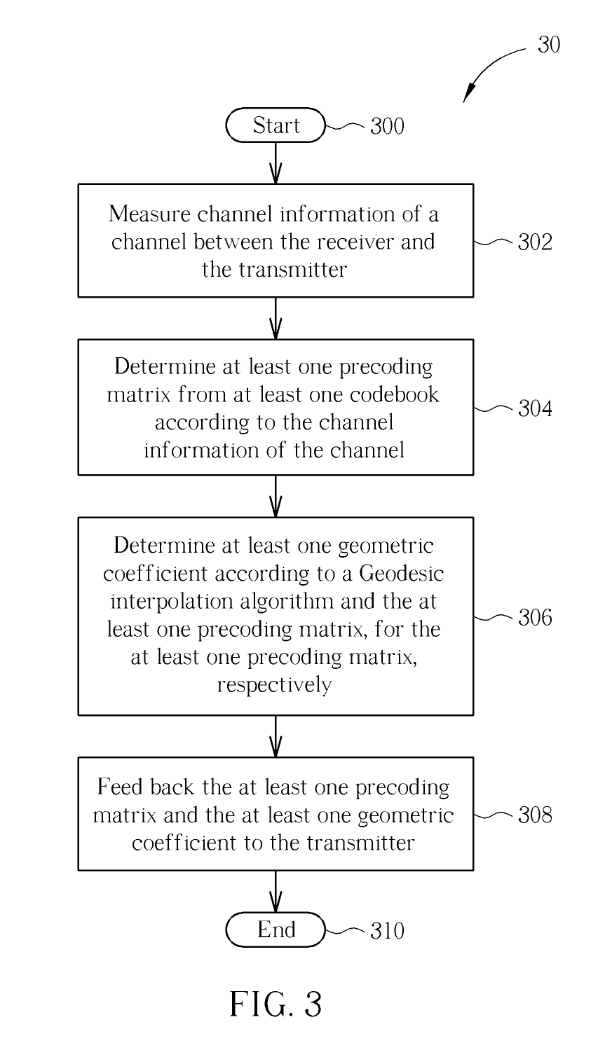

Please refer to FIG. 3, which is a flowchart of a process 30 according to an example of the present invention. The process 30 is utilized in a receiver which maybe a UE or the network shown in FIG. 1, for reducing overhead and quantization error caused by precoding when the precoding is applied to the MIMO or the MISO between the transmitter and the receiver. When the UE is the receiver, the network is the transmitter; when the network is the receiver, the UE is the transmitter. The process 30 may be compiled into the program code 214 and includes the following steps:

Step 300: Start.

Step 302: Measure channel information of a channel between the receiver and the transmitter.

Step 304: Determine at least one precoding matrix from at least one codebook according to the channel information of the channel.

Step 306: Determine at least one geometric coefficient according to a Geodesic interpolation algorithm and the at least one precoding matrix, for the at least one precoding matrix, respectively.

Step 308: Feed back the at least one precoding matrix and the at least one geometric coefficient to the transmitter.

Step 310: End.

According to the process 30, after the receiver measures the channel information (e.g. channel state information (CSI), channel qualities, etc.) of the channel (i.e. sub-channels generated by the MIMO) between the receiver and the transmitter, the receiver determines the at least one precoding matrix from the at least one codebook (e.g. random quantization codebook, discrete Fourier transform (DFT) codebook and/or Householder codebook) according to the channel information of the channel. Further, the receiver determines the at least one geometric coefficient according to the Geodesic interpolation algorithm and the at least one precoding matrix, for the at least one precoding matrix, respectively. Then, the receiver feeds back the at least one precoding matrix and the at least one geometric coefficient to the transmitter. Thus, the transmitter can determine at least one refined precoding matrix according to the Geodesic interpolation algorithm by using the at least one precoding matrix and the at least one geometric coefficient. As a result, the overhead and the quantization error caused by the precoding are reduced by using the at least one refined precoding matrix, and performance (e.g. throughput) of the receiver is further improved due to improved efficiency of the MIMO.

Please note that, a spirit of the process 30 is that the receiver feeds back the at least one precoding matrix and the at least one geometric coefficient determined according to the Geodesic interpolation algorithm to the transmitter such that the transmitter can determine the at least one refined precoding matrix for the precoding, to reduce the overhead and the quantization error caused by the precoding. Realization of the process 30 is not limited. For example, the receiver can feed back only at least one index of the at least one precoding matrix to the transmitter instead of feeding back the at least one precoding matrix, since overhead caused by feeding back the at least one index is much lower than overhead caused by feeding back the at least one precoding matrix. Besides, when the UE is the receiver, the channel is a UL channel; when the network is the receiver, the channel is a DL channel. A method based on which the receiver measures the channel information of the channel is not limited. For example, the receiver can measure the channel information by using at least one reference signal (e.g. pilot signal or sounding signal known by the receiver) transmitted by the transmitter.

On the other hand, the receiver can determine the at least one precoding matrix from the at least one codebook by using a target precoding matrix according to a matrix distance criterion. For example, the receiver determine the at least one precoding matrix by selecting precoding matrices which are closest to the target precoding matrix according to the matrix distance criterion. Realization of the matrix distance criterion is not limited, as long as a distance between two precoding matrices can be properly defined. For example, the matrix distance criterion can be a chordal distance represented as follows:

d(Fᵢ, Fⱼ)=\sqrt{1−|<Fᵢ, Fⱼ>|²}: (Eq. 1)

wherein d(Fᵢ, Fⱼ) is the chordal distance between precoding matrices Fᵢ and Fⱼ, <Fᵢ, Fⱼ> is a matrix inner product of the precoding matrices Fᵢ and Fⱼ, and |x| returns an absolute value of x. Please note that, before using the equation (Eq.1), the precoding matrices Fᵢ and Fⱼ should be normalized first for making d (Fᵢ, Fⱼ) a real number. The matrix inner product is also not limited as long as it satisfies basic properties (i.e. axioms) of an inner product, and is preferably performed according to the following equation:

$$〈 {F}_{i} , {F}_{j} 〉 = {\sum }_{n = 1}^{N} {f}_{i , n}^{*} {f}_{j , n} \text{:} \qquad ( Eq . 2 )$$

wherein * is a conjugate transpose operator, f_{i,n}, 1≦n≦N is the nth column vector of the precoding matrix Fᵢ, and f_{j,n}, 1≦n≦N is the nth column vector of the precoding matrix Fⱼ, wherein n and N are positive integers.

On the other hand, the target precoding matrix can be determined by finding a precoding matrix with maximized performance (e.g. system performance) in a time period according to a performance criterion. Please note that, the time period and the performance criterion can be set according to system requirements and design considerations, and are not limited as long as the target precoding matrix can be properly determined. For example, the time period is a time interval between which the receiver feeds back the at least one precoding matrix to the transmitter. The performance criterion can be average data transmission throughput of the receiver, average channel capacity of the receiver, etc. Two examples of finding the target precoding matrix are illustrated as follows. For example, the target precoding matrix is a best precoding matrix in the at least one codebook, and is determined from the at least one codebook according to the following equation:

$${F}_{b} = arg {max}_{{F}_{i} ∈ B} {log}_{2} ( det ( {I}_{M} + \frac{{E}_{s}}{{MN}_{o}} {F}_{i}^{*} {H}^{*} H {F}_{i} ) ) \text{:} \qquad ( Eq . 3 )$$

wherein F_{b} is the best precoding matrix, M is the stream number of the MIMO, I_{M} is an identity matrix with a dimension of M, B is a plurality of precoding matrices in the at least one codebook, Fᵢ is a precoding matrix in B, Eₛ is total transmit energy in a symbol time, Nₒ is noise power, H is a channel matrix related to the channel information, * is a conjugate transpose operator, and det ( ) is a determinant operator. Alternatively, the target precoding matrix is an optimal precoding matrix (i.e., globally optimal), and is determined according to the following equation:

$${F}_{o} = {argmax}_{F ∈ {C}^{{M}_{t} \times M}} {log}_{2} ( det ( {I}_{M} + \frac{{E}_{s}}{{MN}_{o}} {F}^{*} {H}^{*} H F ) ) \text{:} \qquad ( Eq . 4 )$$

wherein Fₒ is the optimal precoding matrix, M is the stream number of the MIMO, I_{M} is the identity matrix with the dimension of M, C^{M}^{ₜ}^{×M} is a Mₜ×M matrix space with complex scalar, Mₜ is an amount of transmit antennas at the transmitter, F is a precoding matrix in the matrix space C^{M}^{ₜ}^{×M}, Eₛ is the total transmit energy in the symbol time, Nₒ is the noise power, H is the channel matrix related to the channel information, * is the conjugate transpose operator, and det ( ) is the determinant operator. Different from the best precoding matrix, the optimal precoding matrix is not necessarily in the at least one codebook since the optimal precoding matrix is globally optimal.

On the other hand, a method based on which the transmitter determines the at least one refined precoding matrix according to the Geodesic interpolation algorithm is not limited. For example, the transmitter can determine the at least one refined precoding matrix according to the Geodesic interpolation algorithm, the at least one precoding matrix and the at least one geometric coefficient. In detail, the transmitter can determine the at least one refined precoding matrix iteratively by using the at least one precoding matrix, a vertical matrix, a step angle and an adjustment phase according to the Geodesic interpolation algorithm. Preferably, the step angle and the adjustment phase are included in the at least one geometric coefficient, and are fed back from the receiver to the transmitter. In detail, the at least one refined precoding matrix can be determined according to the following equation:

Rₖ=Rₖ₋₁ cos (θₖ)+bₖe^{jv} sin (θₖ): (Eq. 5)

wherein Rₖ is a resulted precoding matrix for the at least one refined precoding matrix obtained in a kth iteration, bₖ is the vertical matrix for the kth iteration, θₖ is the step angle for the kth iteration, and Φₖ is the adjustment phase for the kth iteration. Preferably, a resulted precoding matrix R₀ comprised in the at least one precoding matrix is determined according to minimizing a matrix distance between the resulted precoding matrix R₀ and a target precoding matrix (e.g. the best precoding matrix or the optimal precoding matrix mentioned above). Besides, the vertical matrix bₖ is a tangent matrix pointing from a resulted precoding matrix Rₖ₋₁ to one of the at least one precoding matrix, \tilde{R}ₖ₋₁, and is determined according to the following equation:

bₖ=normalize (\tilde{R}ₖ₋₁−<Rₖ₋₁, \tilde{R}ₖ₋₁>Rₖ₋₁): (Eq. 6)

wherein <Rₖ₋₁, \tilde{R}ₖ₋₁> is a matrix inner product of the precoding matrices Rₖ₋₁ and \tilde{R}ₖ₋₁, and normalize(X) denotes normalizing a matrix X=[x₁,x₂, . . . , xₙ] by normalizing each column of the matrix X according to normalize

$$( X ) = [ \frac{{x}_{1}}{{‖ {x}_{1} ‖}_{2}} , \frac{{x}_{2}}{{‖ {x}_{2} ‖}_{2}} , … , \frac{{x}_{n}}{{‖ {x}_{n} ‖}_{2}} ] ,$$

wherein ∥ ∥ denotes the Frobenius norm. Besides, for further improving performance of the equation (Eq. 5), one of the at least one precoding matrix can be chosen in each iteration according to an order, for determining each resulted precoding matrix Rₖ. Preferably, the order of the one of the at least one precoding matrix increases with a matrix distance between the one of the at least one precoding matrix and a target precoding matrix (e.g. the best precoding matrix or the optimal precoding matrix mentioned above).

On the other hand, the step angle θₖ can be set according to system requirements and design considerations, and is preferably a matrix distance between a first target precoding matrix and a second target precoding matrix according to a matrix distance criterion, wherein the first target precoding matrix and the second target precoding matrix can be referred to the best precoding matrix and the optimal precoding matrix mentioned above, respectively. Alternatively, the step angle θₖ can be a minimized matrix distance between any precoding matrix in the at least one codebook according to the matrix distance criterion. That is, the step angle θₖ is determined according to sin (θₖ)=min_{F}_{ᵢ}_{,F}_{ⱼ}_{∈B, F}_{ᵢ}_{≠F}_{ⱼ}d(Fᵢ, Fⱼ). Preferably, the minimized matrix distance is known by the transmitter and the receiver. For example, the minimized matrix distance is determined stored in the transmitter and the receiver first.

On the other hand, the adjustment phase Φₖ can also be set according to system requirements and design considerations, and is preferably determined by minimizing a matrix distance between the resulted precoding matrix Rₖ and a target precoding matrix (e.g. the best precoding matrix or the optimal precoding matrix mentioned above). For example, the adjustment phase Φₖ can be determined by solving the following equation:

$${e}^{j {ϕ}_{k}} = \frac{\frac{〈 F , {R}_{k - 1} 〉}{\vert 〈 F , {R}_{k - 1} 〉 \vert}}{( \frac{〈 T , {b}_{k} 〉}{\vert 〈 T , {b}_{k} 〉 \vert} ) ( \frac{〈 F , T 〉}{\vert 〈 F , T 〉 \vert} )} \text{:} \qquad ( Eq . 7 )$$

wherein T is a tangent matrix, F is the target precoding matrix (e.g. the optimal precoding matrix mentioned above), and <X,Y> is a matrix inner product (e.g. the equation (Eq.2)) of the precoding matrices X and Y. Preferably, the tangent matrix T points from the resulted precoding matrix R₀ to the target precoding matrix F. Alternatively, the adjustment phase Φₖ is determined from a plurality of phases by minimizing a matrix distance between the resulted precoding matrix Rₖ and the target precoding matrix. Thus, complexity of determining (i.e. searching) the adjustment phase Φₖ is reduced since the plurality of phases are finite.

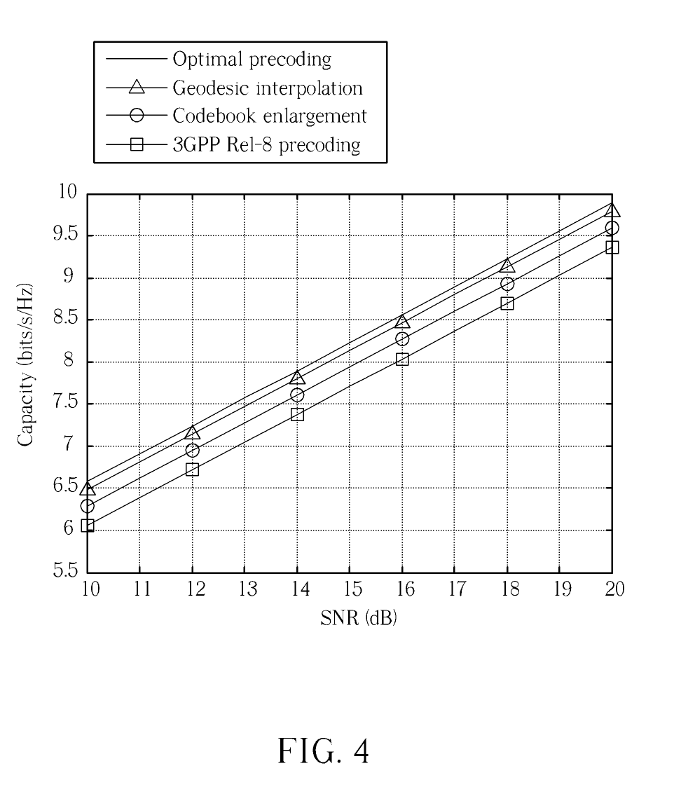

Please refer to FIG. 4, which is a schematic diagram of simulation results for comparing capacities achieved by different precoding methods. Simulations are performed based on the LTE system for demonstrating relations between the capacities and signal-to-noise ratios (SNRs). The capacities achieved by optimal precoding, codebook enlargement, Geodesic interpolation (i.e., the present invention), and the 3GPP Rel-8 precoding are shown in FIG. 4. The optimal precoding assumes that the transmitter knows the channel information of the channel between the transmitter and the receiver perfectly and instantaneously, and precodes data by using the optimal precoding matrix. That is, the capacity achieved by the optimal can be seen as a capacity limit for practical precoding methods . For the rest methods, we assume a time period of 5 ms for feeding back determined precoding matrix. For the codebook enlargement, a Householder codebook is used, wherein the Householder codebook is enlarged from 16 precoding matrices to 736 precoding matrices. For the Geodesic interpolation, only single iteration is used. As shown in FIG. 4, the capacity achieved by the Geodesic interpolation is close to the capacity achieved by the optimal precoding. The Geodesic interpolation has a capacity gain of 0.2 bits/s/Hz over the codebook enlargement, and a capacity gain of 0.5 bits/s/Hz over the 3GPP Rel-8 precoding. Please note that, a size of the enlarged Householder codebook is 46 times larger than a size of the original codebook. Not only storage required for storing the enlarged codebook is increased, but complexity for determining (i.e., searching) the precoding matrix is also increased.

The abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the present invention provides a method of applying Geodesic interpolation to precoding for MIMO between a transmitter and a receiver.

The present invention reduces overhead and quantization error caused by the precoding. Thus, efficiency of the MIMO is improved, and performance (e.g. throughput) of the receiver is improved accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of reducing quantization error caused by precoding for a receiver in a wireless communication system, the method comprising:
measuring channel information of a channel between the receiver and a transmitter in the wireless communication system;
determining at least one precoding matrix from at least one codebook according to the channel information of the channel;
determining at least one geometric coefficient according to a Geodesic interpolation algorithm and the at least one precoding matrix, for the at least one precoding matrix, respectively; and
feeding back the at least one precoding matrix and the at least one geometric coefficient to the transmitter.

2. The method of claim 1, wherein feeding back the at least one precoding matrix to the transmitter comprises:
feeding back the at least one precoding matrix via feeding back at least one index of the at least one precoding matrix to the transmitter.

3. The method of claim 1, wherein determining the at least one precoding matrix from the at least one codebook comprises:
determining the at least one precoding matrix from the at least one codebook by using a target precoding matrix according to a matrix distance criterion.

4. The method of claim 3, wherein the matrix distance criterion is a chordal distance represented as follows:
d(Fᵢ, Fⱼ)=\sqrt{1−|<Fᵢ, Fⱼ>|²},
wherein d(Fᵢ,Fⱼ) is the chordal distance between precoding matrices Fᵢ and Fⱼ, <Fᵢ,Fⱼ> is a matrix inner product of the precoding matrices Fᵢ and Fⱼ, and |x| returns an absolute value of x.

5. The method of claim 4, wherein the matrix inner product is performed according to the following equation:
$$〈 {F}_{i} , {F}_{j} 〉 = {\sum }_{n = 1}^{N} {f}_{i , n}^{*} {f}_{j , n} ,$$
wherein * is a conjugate transpose operator, f_{i,n}, 1≦n≦N is the nth column vector of the precoding matrix Fᵢ, and f_{j,n}, 1≦n≦N is the nth column vector of the precoding matrix Fⱼ.

6. The method of claim 3, wherein the target precoding matrix is determined by finding a precoding matrix with maximized performance in a time period according to a performance criterion.

7. The method of claim 6, wherein the time period is a time interval between which the receiver feeds back the at least one precoding matrix to the transmitter.

8. The method of claim 6, wherein the performance criterion is average data transmission throughput of the receiver.

9. The method of claim 6, wherein the performance criterion is average channel capacity of the receiver.

10. The method of claim 3, wherein the target precoding matrix is comprised in the at least one codebook, and is determined according to the following equation:
$${F}_{b} = arg {max}_{{F}_{i} ∈ B} {log}_{2} ( det ( {I}_{M} + \frac{{E}_{s}}{{MN}_{o}} {F}_{i}^{*} {H}^{*} H {F}_{i} ) ) ,$$
wherein F_{b} is the target precoding matrix, M is a stream number of multiple-input multiple-output (MIMO) of the receiver, I_{M} is an identity matrix with a dimension of M, B is a plurality of precoding matrices in the at least one codebook, Fᵢ is a precoding matrix in B, Eₛ is total transmit energy in a symbol time, Nₒ is noise power, H is a channel matrix related to the channel information, * is a conjugate transpose operator, and det( )is a determinant operator.

11. The method of claim 3, wherein the target precoding matrix is determined according to the following equation:
$${F}_{o} = {argmax}_{F ∈ {C}^{{M}_{t} \times M}} {log}_{2} ( det ( {I}_{M} + \frac{{E}_{s}}{{MN}_{o}} {F}^{*} {H}^{*} H F ) )$$
wherein Fₒ is the target precoding matrix, M is a stream number of MIMO of the receiver, I_{M} is an identity matrix with a dimension of M, C^{M}^{ₜ}^{×M} is a Mₜ×M matrix space with complex scalar, Mₜ is an amount of transmit antennas at the transmitter, F is a precoding matrix in the matrix space C^{M}^{ₜ}^{×M} , Eₛ is total transmit energy in a symbol time, Nₒ is noise power, H is a channel matrix related to the channel information, * is a conjugate transpose operator, and det( ) is a determinant operator.

12. The method of claim 1, wherein the transmitter determines at least one refined precoding matrix according to the Geodesic interpolation algorithm, the at least one precoding matrix and the at least one geometric coefficient.

13. The method of claim 12, wherein the transmitter determines the at least one refined precoding matrix iteratively by using the at least one precoding matrix, a vertical matrix, a step angle and an adjustment phase according to the Geodesic interpolation algorithm.

14. The method of claim 13, wherein the at least one refined precoding matrix is determined according to the following equation:
Rₖ=Rₖ₋₁ cos (θₖ)+bₖe^{jΦ} sin (θₖ),
wherein Rₖ is a resulted precoding matrix for the at least one refined precoding matrix obtained in a kth iteration, bₖ is the vertical matrix for the kth iteration, θₖ is the step angle for the kth iteration, and Φₖ is the adjustment phase for the kth iteration.

15. The method of claim 14, wherein a resulted precoding matrix R₀ is comprised in the at least one precoding matrix, and is determined according to minimizing a matrix distance between the resulted precoding matrix R₀ and a target precoding matrix, wherein the target precoding matrix is a precoding matrix with maximized performance in a time period according to a performance criterion.

16. The method of claim 14, wherein one of the at least one precoding matrix is chosen in each iteration according to an order, for determining each resulted precoding matrix Rₖ.

17. The method of claim 16, wherein the order of the one of the at least one precoding matrix increases with a matrix distance between the one of the at least one precoding matrix and a target precoding matrix, wherein the target precoding matrix is a precoding matrix with maximized performance in a time period according to a performance criterion.

18. The method of claim 14, wherein the step angle θₖ is a matrix distance between a first target precoding matrix and a second target precoding matrix according to a matrix distance criterion, wherein the first target precoding matrix is a precoding matrix comprised in the at least one codebook with maximized performance in a time period according to a performance criterion, and the second target precoding matrix is a precoding matrix with maximized performance in the time period according to the performance criterion.

19. The method of claim 14, wherein the step angle θₖ is a minimized matrix distance between any precoding matrix in the at least one codebook according to a matrix distance criterion.

20. The method of claim 14, wherein the adjustment phase Φₖ is determined by minimizing a matrix distance between the resulted precoding matrix Rₖ and a target precoding matrix, wherein the target precoding matrix is a precoding matrix with maximized performance in a time period according to a performance criterion.
